(19) United States
(12) Patent Application Publication
(10) Pub. No.: US 2024/0351606 A1
(43) Pub. Date: Oct. 24, 2024

(54) AUTONOMOUS VEHICLE DATA PRIORITIZATION AND CLASSIFICATION

(71) Applicant: GM Cruise Holdings LLC, San Francisco, CA (US)

(72) Inventors: Farhan Hormasji, Fremont, CA (US); Anand Natarajan, San Ramon, CA (US)

(21) Appl. No.: 18/302,326

(22) Filed: Apr. 18, 2023

(51) Int. Cl. B60W 60/00; G07C 5/00; G07C 5/08

(52) U.S. Cl. CPC B60W 60/001; G07C 5/008; G07C 5/085

(57) ABSTRACT

Aspects of the disclosed technology provide solutions for autonomous vehicle (AV) data prioritization and in particular, for classifying data stored on an AV based on a prioritization policy. A process of the disclosed technology can include steps for collecting sensor data, wherein the sensor data represents a real-world environment encountered by an autonomous vehicle (AV) and storing the sensor data to a disk drive on the AV. The process can further include steps for receiving, from an autonomous vehicle (AV) fleet center, a prioritization policy, classifying, based on the prioritization policy, the sensor data, and determining if a fill level of the disk drive has exceeded a predetermined threshold. Systems and machine-readable media are also provided.

### BACKGROUND

### 1. Technical Field

The present disclosure generally relates to solutions for autonomous vehicle (AV) data prioritization and in particular, for classifying data stored on an AV based on a prioritization policy.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions conventionally performed by human drivers, such as performing navigation and routing tasks necessary to provide safe and efficient transportation. Such tasks may require the collection and processing of large quantities of data using various sensor types, including but not limited to cameras, Light Detection and Ranging (LiDAR) sensors, and/or Radio Detection and Ranging (RADAR) disposed on the AV. In some instances, the collected data can be used by the AV to perform tasks relating to routing, planning, and obstacle avoidance.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment with an autonomous vehicle (AV) receiving a data prioritization policy, according to some aspects of the disclosed technology.

FIG. 2 illustrates an example of a process for implementing an AV data prioritization policy, according to some aspects of the disclosed technology.

FIG. 3 illustrates another example of a process for implementing an AV data prioritization policy, according to some aspects of the disclosed technology.

FIG. 4 illustrates an example system environment that can be used to facilitate autonomous vehicle (AV) dispatch and navigation operations, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense the environment and move without human input. Automation technology enables the AVs to drive on roadways and to perceive the surrounding environment accurately and quickly, including obstacles, signs, and traffic lights. In some cases, AVs can be used to pick up passengers and drive the passengers to selected destinations.

As discussed above, autonomous vehicles are designed to navigate autonomously in an environment without human input or intervention. During operation, an AV may collect and store data, e.g., sensor data such as LiDAR, RADAR, camera, ultrasonic, Inertial Measurement Unit (IMU), and/or Global Navigation Satellite System (GNSS) data, and the like, pertaining to the surrounding environment. In some cases, AVs can use stored data to improve their performance, identify and correct errors or malfunctions, and comply with regulatory requirements. By way of example, an AV can store data in onboard storage devices including, but not limited to, hard disk drives (HDDs), solid-state drives (SSDs), flash memory, or other types of memory. In some instances, an AV may run out of storage space and, as a result, the AV may need to return to a service center (also AV service center, AV fleet center) to exchange filled storage device with one having available space. To minimize AV downtime, it would be beneficial to increase the storage device's lifespan, i.e., the amount of time taken to reach full-storage capacity.

To improve AV operations in such instances, such as by preventing an AV's storage device from reaching full capacity, it would be helpful to prioritize and classify stored data for potential deletion. Aspects of the disclosed technology provide solutions for improving storage device lifespan by classifying stored data based on a prioritization policy. In some aspects, a prioritization policy can be received by an AV (e.g., from an AV fleet center) that enables an AV to classify stored data based on different metrics as described by the prioritization policy. For example, the prioritization policy may rank different types or subsets of data based on the type of software tool/s that most frequently access or consume that data. By way of example, there may be multiple teams (e.g., engineering, legal, management, etc.) accessing the same subset of AV data using similar (or different) software tools. In such instances, some teams may have higher priority than others and, as a result, the subset of AV data (e.g., within the entire data set on the storage device) accessed by higher priority teams may rank above AV data accessed by lower priority teams. In some approaches, prioritization policy may rank or classify subsets of AV data based on the access frequency for the subsets of AV data by the software tool associated with a team (e.g., AV data frequently accessed by a high priority team's software tool may rank higher than AV data frequently accessed by a low priority team's software tool). As such, data classification may be performed based on an access frequency and/or tool (or team) priority that is associated with the data access.

In some aspects, data classification may be performed based on semantic descriptions of what the data represents. By way of example, a data storage policy may specify certain types of driving scenarios or events (such as rare or long tail events) that should be given storage priority and not deleted when memory resources are low. In such instances, outputs of various layers of the AV software stack may be used to identify high-priority events indicated by the policy, and to attach priority tags/metadata so that the high-priority data does not get deleted. By way of example, semantic outputs from the AVs perception stack may be used to identify certain types of entities (e.g., emergency vehicles, or construction vehicles) and/or certain configurations of objects (such as construction cones surrounding a construction area). Such semantic labeling information may be used to determine/identify the contents of stored data, which can be used (depending on the storage policy) to classify the associated data as high-priority or low priority, etc.

In some aspects, the AVs data prioritization policy may specify specific sensors or AV sub-systems for which data collection should be prioritized. By way of example, the prioritization policy may indicate that data collected from front-facing AV sensors (e.g., LiDAR, RADAR, and/or camera sensors, etc.) should be given priority over data collected by sensors at other locations. It is understood that sensor and/or sub-system prioritization may vary, depending on the desired implementation, without departing from the scope of the subject technology.

In some implementations, the AV may be configured to assess the available storage device capacity (e.g., as a percentage of available space) at predetermined intervals (or continuously) and if it exceeds a predetermined threshold, the AV may delete low ranking or low priority data (e.g., based on classified priority or rank) to free-up available space as described by the prioritization policy. By deleting low-priority data the AV is able to operate for longer durations and to collect data that is more salient/important to AV fleet operations. As such, using the disclosed prioritization approach, aspects of the disclosed technology help to improve the functionality, safety, and comfort of AV operations, e.g., across an AV fleet.

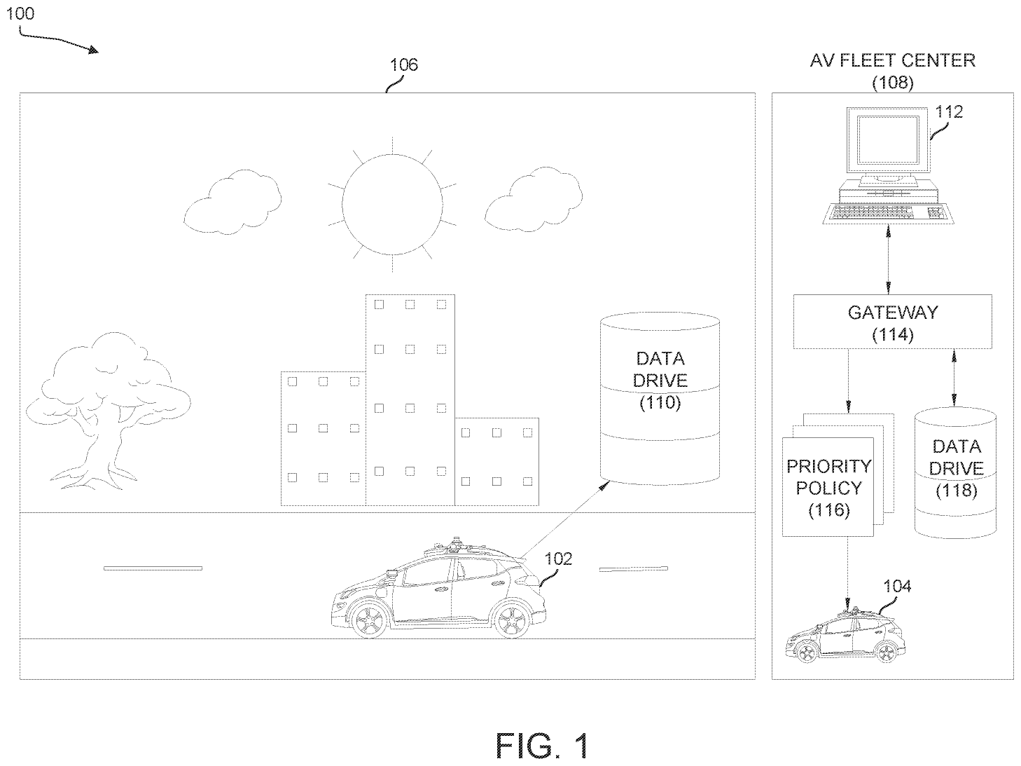

FIG. 1 illustrates an example system environment 100 with an autonomous vehicle (e.g., AV 102) receiving a data priority policy (also prioritization policy) 116. In the example environment 100, AV 102 can be configured to classify and prioritize collected data (e.g., sensor data) stored on data drive (also disk drive) 110. As described herein, AV 102 represents a real-world AV operating in a real-world (physical) environment 106. AV fleet center 108 may include one or more AVs 104 (e.g., a fleet of AVs) that are in storage or currently in service (e.g., maintenance, sensor calibration, software updates, cleaning, and other technical servicing and repairs). By way of example, AV 102 can return to AV fleet center 108 for servicing such as swapping out data drive 110 with an empty drive if data drive 110 reaches full capacity.

AV fleet center 108 can include one or more computers 112 comprising one or more software tools (not illustrated) capable of communicating with gateway 114. The gateway 114 can be software that may interface with data drive 118. As described herein, data drive 118 can represent any on-board storage device (e.g., data drive 110 from AV 102) from any autonomous vehicle within AV fleet 104. The data drive 118 may include sensor data, navigation data, environmental data, vehicle data, user data, communication data, and all other data collected and stored by AV 102. In some instances, data stored on data drive 118 may be accessed via a software tool (e.g., installed on computer 112) via gateway 114. The gateway 114 may track one or more metrics pertaining to the data that is accessed (e.g., via the software tool on computer 112) stored on data drive 118. A priority policy 116 may be generated from metrics tracked by gateway 114. Priority policy 116 can use the metrics to prioritize (e.g., classify as low priority or high priority) or rank subsets of data within data drive 118 in order of importance. Data that is classified as low priority or low rank may be deleted from a data drive 110 (e.g., from an active AV 102 autonomously navigating environment 106) before data that is classified as high priority or high rank.

There may be one or more teams (also groups, organizations) each with their own respective software tool to access data within data drive 118. The gateway 114 may track the software tool used to access data on data drive 118. Example teams may include, but are not limited to, engineering, legal, management, C-suite, service, technicians, human resources, finance, maintenance, etc.

For example, engineering may use its own software tool to access data retrieved from data drive 118 via gateway 114. Other teams may use different software tools or share the same software tools to access data on data drive 118. One metric that gateway 114 can track is the subset of data (e.g., within the entire data set) accessed by a team stored on data drive 118 and the type of software tool in use (e.g., the engineering team may use its own software tool). Another metric gateway 114 can track is the frequency of access for subsets of data stored on data drive 118. Also, there may be entire teams and associated software tools that are higher priority than other teams. For example, the software tool used by the engineering team may be higher priority than the software tool used by another group or team. As such, access by those high-priority teams (or tools) may be reflected in the prioritization policy, e.g., where data accessed by high priority teams and/or tools are indicated as higher priority, as compared with those accessed by lower priority teams and/or tools. Those skilled in the art will appreciate that additional software tool metrics can be tracked by gateway 114, without departing from the scope of the disclosed technology.

In some aspects, data pipeline access can be used to determine priority policies. For example, data pipeline owners may request that certain prioritization policies be assigned to certain stores (or types) of data, for example, that are aligned with a particular pipeline use case. In some aspects, pipeline access may be used to determine data prioritization. For example, if a set of data is frequently accessed by high priority pipelines, then the data may be given higher priority in the prioritization policy. By way of further example, if a first set of data is accessed infrequently by a set of high priority pipelines, whereas a second set of data is frequently accessed by a set of lower priority pipelines, then the first set of data may be deemed to be of higher priority (as reflected in the priority policy) as compared to the second set of data, e.g., based on the higher priority of the high priority pipelines.

In other implementations, data priority may be conditioned on a specified pipeline use case or set of pipeline use cases. For example, access of data by one or more pipelines with pre-specified (high priority) use cases may be sufficient to deem the data as high priority in the associated priority policy. In this way, data associated with critical use cases, such as those relevant to AV safety or standards conformity, may result in the flagging of accessed data as high priority in the priority policy.

In addition to tracking metrics pertaining to the software tool or pipeline used to access data drive 118 as discussed above, gateway 114 can track other types of metrics. In another example, gateway 114 can track metrics for the specific user or team (group of users) accessing data on data drive 118. In other words, gateway 114 may track a user's title, role, position, seniority, access frequency (e.g., how often a user is accessing a subset of data on drive 118), user priority, team priority or other metrics pertaining to a user or a team.

The metrics tracked (e.g., for all the teams) by gateway 114 can be used to generate prioritization policy 116. For example, prioritization policy 116 can use the metrics generated by gateway 114 to rank or classify the priority (e.g., high priority or low priority) of subsets of data on drive 118. For example, if a subset of data was accessed frequently, then that respective subset of data can be classified as high priority. Prioritization policy 116 can also classify data on data drive 118 without using metrics from gateway 114. For example, prioritization policy 116 may designate data categories as high priority or low priority. In another example, prioritization policy 116 may account for a cost metric (e.g., computational cost or computational resources) associated with a subset of data. In some cases, prioritization policy 116 may be generated manually (e.g., via a human user) based on the metrics derived from gateway 114. In other words, a user may analyze the metrics from gateway 114 to classify subsets of data within data drive 118 as high or low priority or rank the subsets of data in order of importance. In some instances, prioritization policy 116 may be generated automatically via software and/or machine learning algorithms. For example, software and/or machine learning algorithms may analyze the metrics derived from gateway 114 to classify or rank the subsets of data within data drive 118.

In some aspects, prioritization policy 116 may be shared with the fleet of AVs 104 (e.g., all A Vs including AV 102 within AV fleet center 108 may receive prioritization policy 116). For example, AV 102 may store prioritization policy 116 on the local computing device (e.g., local computing device 410). As described above, AV 102 may collect and store sensor data pertaining to the surrounding environment 106 on data drive 110. If data drive 110 reaches a predetermined threshold (e.g., is near capacity), then AV 102 may utilize prioritization policy 116 to determine which subset of data to delete (e.g., automatically delete) and create more available storage space on data drive 110. If data drive 110 does not reach a predetermined threshold (e.g., there is still available storage space), then AV 102 may continue collecting sensor data. The data may be deleted while AV 102 is autonomously navigating environment 106 which can enable AV 102 to continue operating without returning to AV fleet center 108 due to data drive 110 reaching full-capacity.

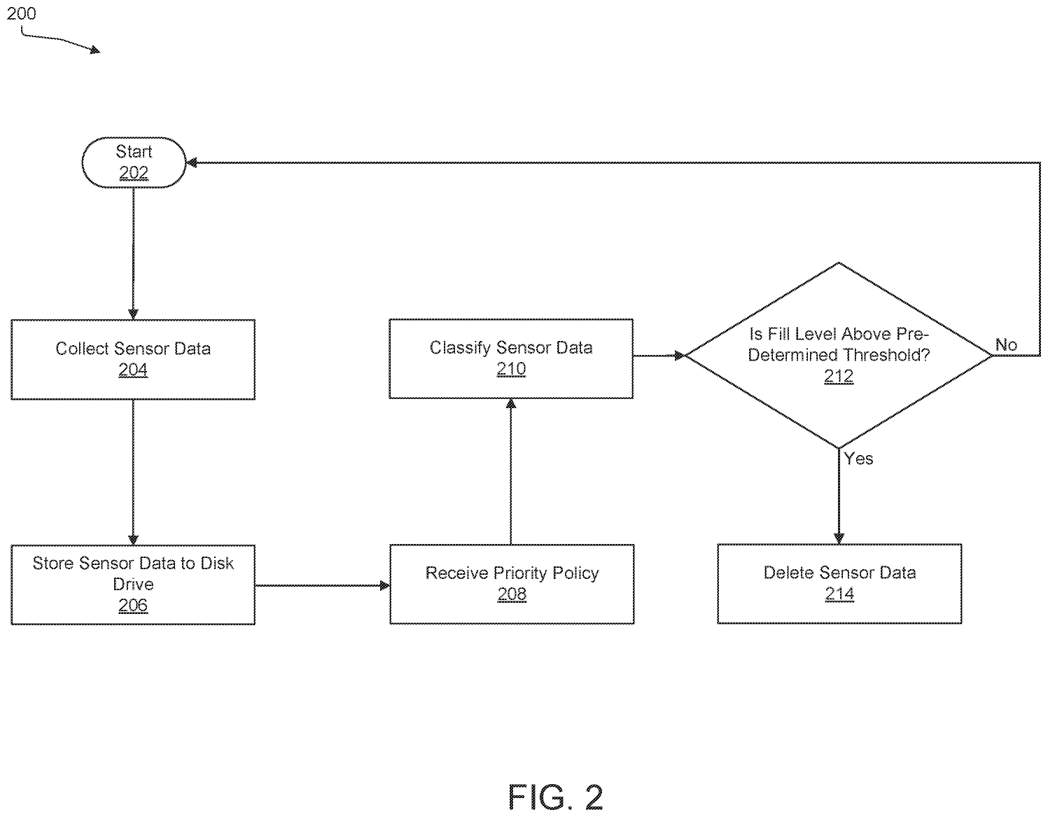

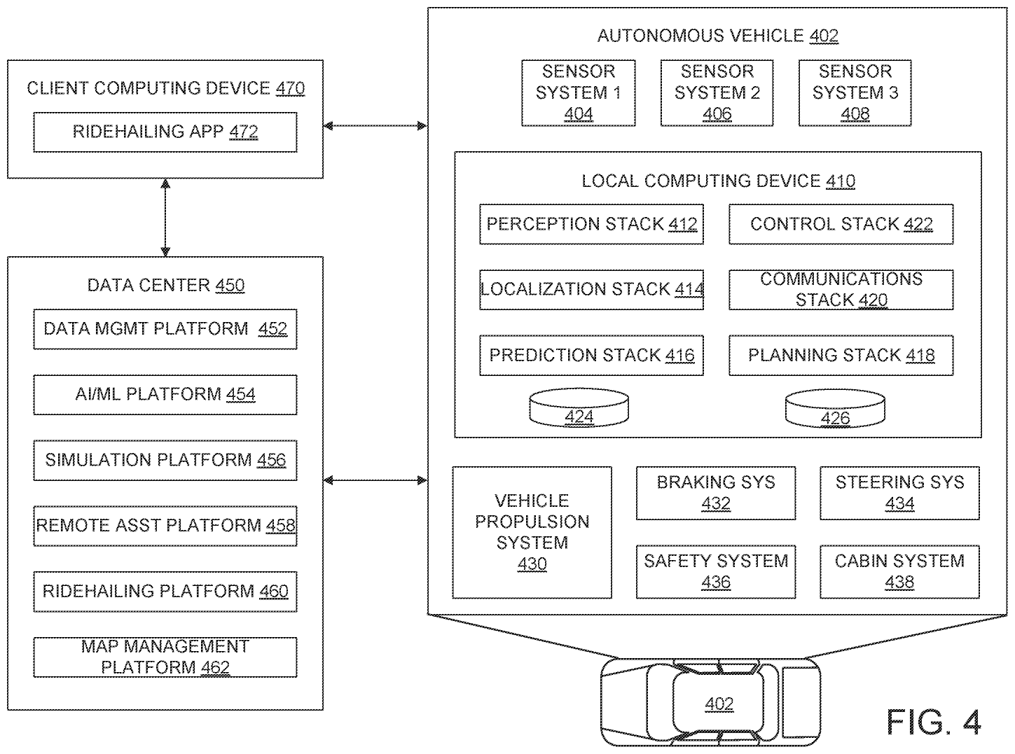

FIG. 2 illustrates an example process 200 for implementing an AV data prioritization policy. In some examples, process 200 may start at step 202 to begin data prioritization and classification. At step 204, an AV navigating a real-world environment (e.g., AV 102) can collect sensor data (e.g., LiDAR, RADAR, camera, ultrasonic, IMU, GNSS as illustrated by sensor systems 404, 406 and 408 in FIG. 4). The collected data can include determinations made by various layers of the AV stack, such as identifications of specific objects, driving scenarios and/or perceptions of the AV.

At step 206, the AV can store the collected sensor data to a disk drive (e.g., data drive 110). For example, the AV can store sensor data on a hard disk drive, solid-state drive, or other type of memory located on the AV. At step 208, the AV can receive a priority policy. For example, the AV can receive a priority policy from an AV fleet center (e.g., AV fleet center 108) while autonomously navigating an environment (e.g., environment 106) or while the AV is at the AV fleet center (e.g., during service or storage).

At step 210, the AV can classify the sensor data as high priority, low priority, or rank the sensor data in another order of priority based on what is indicated by the priority policy received at step 208. For example, the local computing device (e.g., local computing device 410) of the AV can analyze and process the priority policy to classify the sensor data.

At step 212, process 200 can determine whether or not the fill level of the data drive 110 on AV 102 is above a predetermined threshold. For example, a predetermined threshold may be sent to (e.g., via AV fleet center 108) or stored on the AV as a percentage value indicating the percentage of memory used on the data drive of the AV. If it is determined that the fill level of the disk drive is above the predetermined threshold (e.g., the memory is filled above the percentage value as indicated by the predetermined threshold), then the process can continue to step 214. At step 214, the AV can delete sensor data that is classified as low priority or delete the sensor data in order of priority (e.g., the data is deleted based on the classified rank, where the lowest ranked data is deleted first followed by the second lowest ranked data and so forth). If it is determined that the fill level is not above the predetermined threshold, then the process 200 can return to step 202 to continue collecting sensor data and storing the data to the disk drive.

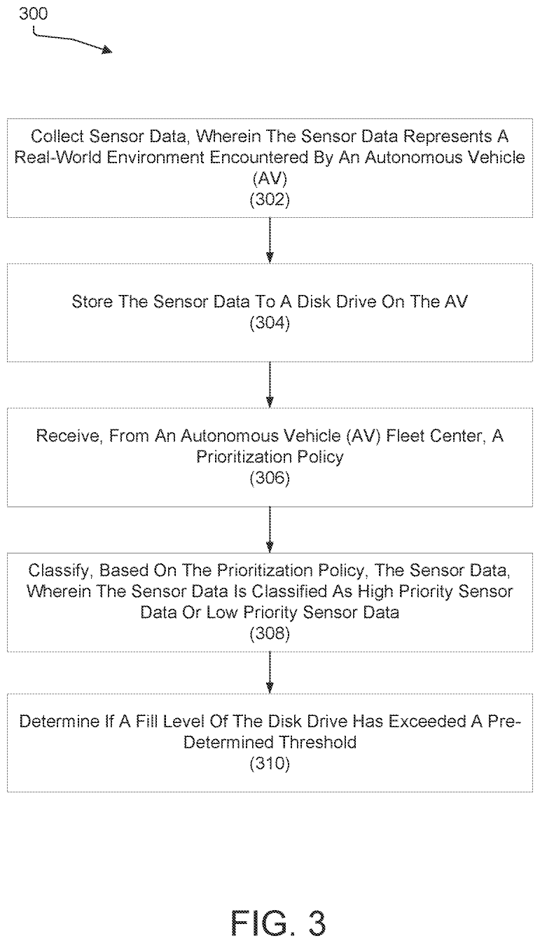

FIG. 3 illustrates another process 300 for implementing an AV data prioritization policy. At block 302, process 300 includes collecting sensor data, wherein the sensor data represents a real-world environment encountered by an autonomous vehicle (AV). For example, AV 102 navigating a real-world environment 106 can collect sensor data using sensor systems 404, 406 and 408.

At step 304, process 300 includes storing the sensor data to a disk drive on the AV. For example, AV 102 can store the sensor data on data drive 110. At block 306, process 300 includes receiving, from an autonomous vehicle (AV) fleet center, a prioritization policy. For example, AV fleet center 108 can send or install priority policy 116 on the fleet of AVs 104 including AV 102.

At block 308, process 300 includes classifying, based on the prioritization policy, the sensor data, wherein the sensor data is classified as high priority sensor data or low priority sensor data. For example, computing device 410 of AV 102 can analyze priority policy 116 and classify the collected data stored on data drive 110 as high priority or low priority based on the metrics or instructions of priority policy 116.

At step 310, process 300 includes determining if a fill level of the disk drive has exceeded a predetermined threshold. For example, local computing device 410 of AV 102 may determine if the fill level (e.g., percentage of memory used on data drive 110) is above a predetermined threshold or value. In some cases, the predetermined threshold can be received by AV fleet center 108 or determined using machine learning algorithms. By way of example, the threshold may be dynamically set based on a data fill rate of the data drive, and/or based on complexity considerations, for example, of driving scenarios in which the AV is operating. By way of example, the threshold fill level may be set lower (e.g., to delete superfluous data sooner) if data acquisition is happening quickly (e.g., while the AV is navigating in a complex driving environment), as compared to if the AV is operating in a lower-complexity environment, such as an open stretch of highway with few vehicles or traffic control signs/lights, etc.

In some examples, process 300 can further include determining that the fill level has exceeded the predetermined threshold and automatically deleting the low priority sensor data. For example, if the fill level of data drive 110 is above the predetermined threshold, then AV 102 can delete the low priority data (e.g., as classified in step 308). In some examples, the prioritization policy is generated using machine learning algorithms. For example, machine learning algorithms or a deep learning neural network on AV 102 may be used to generate priority policy 116.

FIG. 4 is a diagram illustrating an example autonomous vehicle (AV) environment 400, according to some examples of the present disclosure. One of ordinary skill in the art will understand that, for AV environment 400 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 402 can navigate roadways without a human driver based on sensor signals generated by multiple sensor systems 404, 406, and 408. The sensor systems 404-408 can include one or more types of sensors and can be arranged about the AV 402. For instance, the sensor systems 404-408 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other examples may include any other number and type of sensors.

The AV 402 can also include several mechanical systems that can be used to maneuver or operate the AV 402. For instance, the mechanical systems can include a vehicle propulsion system 430, a braking system 432, a steering system 434, a safety system 436, and a cabin system 438, among other systems. The vehicle propulsion system 430 can include an electric motor, an internal combustion engine, or both. The braking system 432 can include an engine brake, brake pads, actuators, and/or any other suitable componentry configured to assist in decelerating the AV 402. The steering system 434 can include suitable componentry configured to control the direction of movement of the AV 402 during navigation. The safety system 436 can include lights and signal indicators, a parking brake, airbags, and so forth. The cabin system 438 can include cabin temperature control systems, in-cabin entertainment systems, and so forth. In some examples, the AV 402 might not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

The AV 402 can include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a localization stack 414, a prediction stack 416, a planning stack 418, a communications stack 420, a control stack 422, an AV operational database 424, and an HD geospatial database 426, among other stacks and systems.

Perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the localization stack 414, the HD geospatial database 426, other components of the AV, and other data sources (e.g., the data center 450, the client computing device 470, third party data sources, etc.). The perception stack 412 can detect and classify objects and determine their current locations, speeds, directions, and the like. In addition, the perception stack 412 can determine the free space around the AV 402 (e.g., to maintain a safe distance from other objects, change lanes, park the AV, etc.). The perception stack 412 can identify environmental uncertainties, such as where to look for moving objects, flag areas that may be obscured or blocked from view, and so forth. In some examples, an output of the perception stack 412 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 414 can determine the AV's position and orientation (pose) using different methods from multiple systems (e.g., GPS, IMUs, cameras, LIDAR, RADAR, ultrasonic sensors, the HD geospatial database 426, etc.). For example, in some cases, the AV 402 can compare sensor data captured in real-time by the sensor systems 404-408 to data in the HD geospatial database 426 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LIDAR). If the mapping and localization information from one system is unavailable, the AV 402 can use mapping and localization information from a redundant system and/or from remote data sources.

Prediction stack 416 can receive information from the localization stack 414 and objects identified by the perception stack 412 and predict a future path for the objects. In some examples, the prediction stack 416 can output several likely paths that an object is predicted to take along with a probability associated with each path. For each predicted path, the prediction stack 416 can also output a range of points along the path corresponding to a predicted location of the object along the path at future time intervals along with an expected error value for each of the points that indicates a probabilistic deviation from that point.

Planning stack 418 can determine how to maneuver or operate the AV 402 safely and efficiently in its environment. For example, the planning stack 418 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another and outputs from the perception stack 412, localization stack 414, and prediction stack 416. The planning stack 418 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 418 can select from multiple backup plans to carry out. For example, while preparing to change lanes to turn right at an intersection, another vehicle may aggressively cut into the destination lane, making the lane change unsafe. The planning stack 418 could have already determined an alternative plan for such an event. Upon its occurrence, it could help direct the AV 402 to go around the block instead of blocking a current lane while waiting for an opening to change lanes.

Control stack 422 can manage the operation of the vehicle propulsion system 430, the braking system 432, the steering system 434, the safety system 436, and the cabin system 438. The control stack 422 can receive sensor signals from the sensor systems 404-408 as well as communicate with other stacks or components of the local computing device 410 or a remote system (e.g., the data center 450) to effectuate operation of the AV 402. For example, the control stack 422 can implement the final path or actions from the multiple paths or actions provided by the planning stack 418. This can involve turning the routes and decisions from the planning stack 418 into commands for the actuators that control the AV's steering, throttle, brake, and drive unit.

Communications stack 420 can transmit and receive signals between the various stacks and other components of the AV 402 and between the AV 402, the data center 450, the client computing device 470, and other remote systems. The communications stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 420 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 426 can store HD maps and related data of the streets upon which the AV 402 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 424 can store raw AV data generated by the sensor systems 404-408, stacks 412-422, and other components of the AV 402 and/or data received by the AV 402 from remote systems (e.g., the data center 450, the client computing device 470, etc.). In some examples, the raw AV data can include HD LIDAR point cloud data, image data, RADAR data, GPS data, and other sensor data that the data center 450 can use for creating or updating AV geospatial data or for creating simulations of situations encountered by AV 402 for future testing or training of various machine learning algorithms that are incorporated in the local computing device 410.

Data center 450 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 450 can include one or more computing devices remote to the local computing device 410 for managing a fleet of AVs and AV-related services. For example, in addition to managing the AV 402, the data center 450 may also support a ride-hailing service (e.g., a ridesharing service), a delivery service, a remote/roadside assistance service, street services (e.g., street mapping, street patrol, street cleaning, street metering, parking reservation, etc.), and the like.

Data center 450 can send and receive various signals to and from the AV 402 and the client computing device 470. These signals can include sensor data captured by the sensor systems 404-408, roadside assistance requests, software updates, ride-hailing/ridesharing pick-up and drop-off instructions, and so forth. In this example, the data center 450 includes a data management platform 452, an Artificial Intelligence/Machine Learning (AI/ML) platform 454, a simulation platform 456, a remote assistance platform 458, and a ride-hailing platform 460, and a map management platform 462, among other systems.

Data management platform 452 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ride-hailing platform 460, the map management platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

Simulation platform 456 can enable testing and validation of the algorithms, machine learning models, neural networks, and other development efforts for the AV 402, the remote assistance platform 458, the ride-hailing platform 460, the map management platform 462, and other platforms and systems. Simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from a cartography platform (e.g., map management platform 462); modeling the behavior of other vehicles, bicycles, pedestrians, and other dynamic elements; simulating inclement weather conditions, different traffic scenarios; and so on.

Remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

Ride-hailing platform 460 can interact with a customer of a ride-hailing service via a ride-hailing application 472 executing on the client computing device 470. The client computing device 470 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 472. The client computing device 470 can be a customer's mobile computing device or a computing device integrated with the AV 402 (e.g., the local computing device 410). The ride-hailing platform 460 can receive requests to pick up or drop off from the ride-hailing application 472 and dispatch the AV 402 for the trip.

Map management platform 462 can provide a set of tools for the manipulation and management of geographic and spatial (geospatial) and related attribute data. The data management platform 452 can receive LIDAR point cloud data, image data (e.g., still image, video, etc.), RADAR data, GPS data, and other sensor data (e.g., raw data) from one or more AVs 402, Unmanned Aerial Vehicles (UAVs), satellites, third-party mapping services, and other sources of geospatially referenced data. The raw data can be processed, and map management platform 462 can render base representations (e.g., tiles (2D), bounding volumes (3D), etc.) of the AV geospatial data to enable users to view, query, label, edit, and otherwise interact with the data. Map management platform 462 can manage workflows and tasks for operating on the AV geospatial data. Map management platform 462 can control access to the AV geospatial data, including granting or limiting access to the AV geospatial data based on user-based, role-based, group-based, task-based, and other attribute-based access control mechanisms. Map management platform 462 can provide version control for the AV geospatial data, such as to track specific changes that (human or machine) map editors have made to the data and to revert changes when necessary. Map management platform 462 can administer release management of the AV geospatial data, including distributing suitable iterations of the data to different users, computing devices, AVs, and other consumers of HD maps. Map management platform 462 can provide analytics regarding the AV geospatial data and related data, such as to generate insights relating to the throughput and quality of mapping tasks.

In some embodiments, the map viewing services of map management platform 462 can be modularized and deployed as part of one or more of the platforms and systems of the data center 450. For example, the AI/ML platform 454 may incorporate the map viewing services for visualizing the effectiveness of various object detection or object classification models, the simulation platform 456 may incorporate the map viewing services for recreating and visualizing certain driving scenarios, the remote assistance platform 458 may incorporate the map viewing services for replaying traffic incidents to facilitate and coordinate aid, the ride-hailing platform 460 may incorporate the map viewing services into the client application 472 to enable passengers to view the AV 402 in transit en route to a pick-up or drop-off location, and so on.

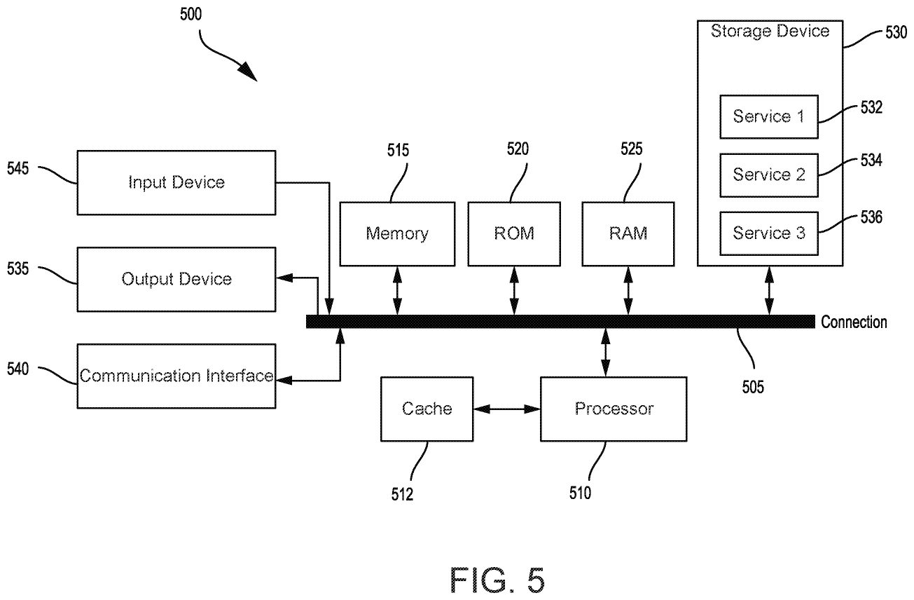

While the autonomous vehicle 402, the local computing device 410, and the autonomous vehicle environment 400 are shown to include certain systems and components, one of ordinary skill will appreciate that the autonomous vehicle 402, the local computing device 410, and/or the autonomous vehicle environment 400 can include more or fewer systems and/or components than those shown in FIG. 4. For example, the autonomous vehicle 402 can include other services than those shown in FIG. 4 and the local computing device 410 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 4. An illustrative example of a computing device and hardware components that can be implemented with the local computing device 410 is described below with respect to FIG. 5.

FIG. 5 illustrates an example processor-based system with which some aspects of the subject technology can be implemented. For example, processor-based system 500 can be any computing device making up, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (Central Processing Unit (CPU) or processor) 510 and connection 505 that couples various system components including system memory 515, such as Read-Only Memory (ROM) 520 and Random-Access Memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASH EPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 530 can include software services, servers, services, etc., when the code that defines such software is executed by the processor 510, it causes the system 500 to perform a function. In some embodiments, a hardware service that performs a particular function can include the software component stored in a computer-readable medium in connection with the necessary hardware components, such as processor 510, connection 505, output device 535, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative examples of the disclosure include:

Aspect 1. An apparatus comprising: at least one memory; and at least one processor coupled to the at least one memory, the at least one processor configured to: collect sensor data, wherein the sensor data represents a real-world environment encountered by an autonomous vehicle (AV); store the sensor data to a disk drive on the AV; receive, from an autonomous vehicle (AV) fleet center, a prioritization policy; classify, based on the prioritization policy, the sensor data, wherein the sensor data is classified as high priority sensor data or low priority sensor data; and determine if a fill level of the disk drive has exceeded a predetermined threshold.

Aspect 2. The apparatus of Aspect 1, wherein the at least one processor is further configured to: if it is determined that the fill level has exceeded the predetermined threshold, automatically delete the low priority sensor data.

Aspect 3. The apparatus of any of Aspects 1-2, wherein the prioritization policy is generated using machine learning algorithms.

Aspect 4. The apparatus of any of Aspects 1-3, wherein the prioritization policy is based on a set of metrics derived from a software tool used to access a subset of the sensor data, and wherein the set of metrics is based on at least one of access frequency of the subset of sensor data, priority of the software tool, or a combination thereof.

Aspect 5. The apparatus of any of Aspects 1-4, wherein the prioritization policy is based on a second set of metrics used to access a second subset of the sensor data, and wherein the second set of metrics is based on at least one of user access frequency of the second subset of sensor data, user title, team priority, or a combination thereof.

Aspect 6. The apparatus of any of Aspects 1-5, wherein the prioritization policy is based on a data category associated with the sensor data.

Aspect 7. The apparatus of any of Aspects 1-6, wherein the prioritization policy is based on a cost metric associated with the sensor data.

Aspect 8. A method comprising: collecting sensor data, wherein the sensor data represents a real-world environment encountered by an autonomous vehicle (AV); storing the sensor data to a disk drive on the AV; receiving, from an autonomous vehicle (AV) fleet center, a prioritization policy; classifying, based on the prioritization policy, the sensor data, wherein the sensor data is classified as high priority sensor data or low priority sensor data; and determining if a fill level of the disk drive has exceeded a predetermined threshold.

Aspect 9. The method of Aspect 8, further comprising: if it is determined that the fill level has exceeded the predetermined threshold, automatically deleting the low priority sensor data.

Aspect 10. The method of any of Aspects 8-9, wherein the prioritization policy is generated using machine learning algorithms.

Aspect 11. The method of any of Aspects 8-10, wherein the prioritization policy is based on a set of metrics derived from a software tool used to access a subset of the sensor data, and wherein the set of metrics is based on at least one of access frequency of the subset of sensor data, priority of the software tool, or a combination thereof.

Aspect 12. The method of any of Aspects 8-11, wherein the prioritization policy is based on a second set of metrics used to access a second subset of the sensor data, and wherein the second set of metrics is based on at least one of user access frequency of the second subset of sensor data, user title, team priority, or a combination thereof.

Aspect 13. The method of any of Aspects 8-12, wherein the prioritization policy is based on a data category associated with the sensor data.

Aspect 14. The method of any of Aspects 8-13, wherein the prioritization policy is based on a cost metric associated with the sensor data.

Aspect 15. A non-transitory computer-readable storage medium comprising at least one instruction for causing a computer or processor to: collect sensor data, wherein the sensor data represents a real-world environment encountered by an autonomous vehicle (AV); store the sensor data to a disk drive on the AV; receive, from an autonomous vehicle (AV) fleet center, a prioritization policy; classify, based on the prioritization policy, the sensor data, wherein the sensor data is classified as high priority sensor data or low priority sensor data; and determine if a fill level of the disk drive has exceeded a predetermined threshold.

Aspect 16. The non-transitory computer-readable storage medium of Aspect 15, wherein the at least one instruction is further configured to: if it is determined that the fill level has exceeded the predetermined threshold, automatically delete the low priority sensor data.

Aspect 17. The non-transitory computer-readable storage medium of any of Aspects 15-16, wherein the prioritization policy is generated using machine learning algorithms.

Aspect 18. The non-transitory computer-readable storage medium of any of Aspects 15-17, wherein the prioritization policy is based on a set of metrics derived from a software tool used to access a subset of the sensor data, and wherein the set of metrics is based on at least one of access frequency of the subset of sensor data, priority of the software tool, or a combination thereof.

Aspect 19. The non-transitory computer-readable storage medium of any of Aspects 15-18, wherein the prioritization policy is based on a second set of metrics used to access a second subset of the sensor data, and wherein the second set of metrics is based on at least one of user access frequency of the second subset of sensor data, user title, team priority, or a combination thereof.

Aspect 20. The non-transitory computer-readable storage medium of any of Aspects 15-19, wherein the prioritization policy is based on a data category associated with the sensor data.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An apparatus comprising:
at least one memory; and
at least one processor coupled to the at least one memory, the at least one processor configured to:
collect sensor data, wherein the sensor data represents a real-world environment encountered by an autonomous vehicle (AV);
store the sensor data to a disk drive on the AV;
receive, from an autonomous vehicle (AV) fleet center, a prioritization policy;
classify, based on the prioritization policy, the sensor data, wherein the sensor data is classified as high priority sensor data or low priority sensor data; and
determine if a fill level of the disk drive has exceeded a predetermined threshold.

2. The apparatus of claim 1, wherein the at least one processor is further configured to:
automatically delete the low priority sensor data, if it is determined that the fill level has exceeded the predetermined threshold.

3. The apparatus of claim 1, wherein the prioritization policy is generated using machine learning algorithms.

4. The apparatus of claim 1, wherein the prioritization policy is based on a set of metrics derived from a software tool used to access a subset of the sensor data, and wherein the set of metrics is based on an access frequency of the subset of sensor data, a priority of the software tool, or a combination thereof.

5. The apparatus of claim 1, wherein the prioritization policy is based on a second set of metrics used to access a second subset of the sensor data, and wherein the second set of metrics is based on at least one of user access frequency of the second subset of sensor data, user title, team priority, or a combination thereof.

6. The apparatus of claim 1, wherein the prioritization policy is based on a data category associated with the sensor data.

7. The apparatus of claim 1, wherein the prioritization policy is based on a cost metric associated with the sensor data.

8. A computer-implemented method comprising:
collecting sensor data, wherein the sensor data represents a real-world environment encountered by an autonomous vehicle (AV);
storing the sensor data to a disk drive on the AV;
receiving, from an autonomous vehicle (AV) fleet center, a prioritization policy;
classifying, based on the prioritization policy, the sensor data, wherein the sensor data is classified as high priority sensor data or low priority sensor data; and
determining if a fill level of the disk drive has exceeded a predetermined threshold.

9. The computer-implemented method of claim 8, further comprising:
automatically deleting the low priority sensor data, if it is determined that the fill level has exceeded the predetermined threshold.

10. The computer-implemented method of claim 8, wherein the prioritization policy is generated using machine learning algorithms.

11. The computer-implemented method of claim 8, wherein the prioritization policy is based on a set of metrics derived from a software tool used to access a subset of the sensor data, and wherein the set of metrics is based on at least one of access frequency of the subset of sensor data, priority of the software tool, or a combination thereof.

12. The method of claim 8, wherein the prioritization policy is based on a second set of metrics used to access a second subset of the sensor data, and wherein the second set of metrics is based on at least one of user access frequency of the second subset of sensor data, user title, team priority, or a combination thereof.

13. The computer-implemented method of claim 8, wherein the prioritization policy is based on a data category associated with the sensor data.

14. The computer-implemented method of claim 8, wherein the prioritization policy is based on a cost metric associated with the sensor data.

15. A non-transitory computer-readable storage medium comprising at least one instruction for causing a computer or processor to:
collect sensor data, wherein the sensor data represents a real-world environment encountered by an autonomous vehicle (AV);
store the sensor data to a disk drive on the AV;
receive, from an autonomous vehicle (AV) fleet center, a prioritization policy;
classify, based on the prioritization policy, the sensor data, wherein the sensor data is classified as high priority sensor data or low priority sensor data; and
determine if a fill level of the disk drive has exceeded a predetermined threshold.

16. The non-transitory computer-readable storage medium of claim 15, wherein the at least one instruction is further configured to:
automatically delete the low priority sensor data, if it is determined that the fill level has exceeded the predetermined threshold.

17. The non-transitory computer-readable storage medium of claim 15, wherein the prioritization policy is generated using machine learning algorithms.

18. The non-transitory computer-readable storage medium of claim 15, wherein the prioritization policy is based on a set of metrics derived from a software tool used to access a subset of the sensor data, and wherein the set of metrics is based on at least one of access frequency of the subset of sensor data, priority of the software tool, or a combination thereof.

19. The non-transitory computer-readable storage medium of claim 15, wherein the prioritization policy is based on a second set of metrics used to access a second subset of the sensor data, and wherein the second set of metrics is based on at least one of user access frequency of the second subset of sensor data, user title, team priority, or a combination thereof.

20. The non-transitory computer-readable storage medium of claim 15, wherein the prioritization policy is based on a data category associated with the sensor data.
